(19) United States
(12) Patent Application Publication
(10) Pub. No.: US 2013/0145363 A1
(43) Pub. Date: Jun. 6, 2013

(54) SYSTEM AND METHOD THEREOF FOR RUNNING AN UNMODIFIED GUEST OPERATING SYSTEM IN A PARA-VIRTUALIZED ENVIRONMENT

(71) Applicants: Izik Eidus, Kfar Saba (IL); Leonid Shatz, Ra'anana (IL); Michael Rapoport, Haifa (IL); Alexander Fishman, Netanya (IL)

(72) Inventors: Izik Eidus, Kfar Saba (IL); Leonid Shatz, Ra'anana (IL); Michael Rapoport, Haifa (IL); Alexander Fishman, Netanya (IL)

(73) Assignee: RAVELLO SYSTEMS LTD., Ra'anana (IL)

(21) Appl. No.: 13/426,861

(22) Filed: Mar. 22, 2012

Related U.S. Application Data
(60) Provisional application No. 61/567,110, filed on Dec. 5, 2011.

(51) Int. Cl. G06F 9/455

(52) U.S. Cl. 718/1

(57) ABSTRACT

An apparatus and method of operation in a para-virtualized environment. The method includes executing a first hypervisor on a hardware platform of a computing device; and executing a second hypervisor over the first hypervisor, the second hypervisor is configured to capture at least a privileged instruction called by an unmodified guest program executed over the second hypervisor and cause the first hypervisor to execute an instruction corresponding to the captured privileged instruction, wherein the unmodified guest program and the second hypervisor operate in a user space protection domain, e.g., Ring 3, and the at least privileged instruction should be executed in a kernel space protection domain, e.g., Ring 0.

### CROSS-REFERENCE TO RELATED APPLICATIONS

This application claims priority from U.S. provisional application No. 61/567,110 filed Dec. 5, 2011, the contents of which are herein incorporated by reference.

### TECHNICAL FIELD

The invention generally relates to virtual machines (VMs) and more specifically to execution of a guest in a para-virtualized environment.

### BACKGROUND

There are two known forms of virtualization used today. One form of implementation is full virtualization which allows an unmodified guest operating system (which is also referred to herein simply as a guest) to execute thereon a virtual machine (VM). In this case, the VM sufficiently simulates the hardware on which it executes, such that no modification is required of a guest that runs directly on the host processor. However, full virtualization is possible only when there is the right combination of hardware and software to support it. Such configuration is cumbersome and sometime impractical for some of the more commonly used processor architectures.

An alternative to full virtualization is para-virtualization that comes at a cost of requiring some modifications of the guest. A software interface is used to allow the handling and modifying of the guest, so that the guest can operate in the environment of a para-virtualized system. The advantage is a somewhat simpler system to handle when compared to a full virtualization system, but at a cost of a requirement to modify the guest. In some cases, hardware assisted virtualization is used with respect of para-virtualization to reduce maintenance overhead associated with such para-virtualization.

Spaces, rings or protection rings are hierarchical protection domains utilized to protect data and functionality from faults and malicious actions. Each protection provides different levels of access to hardware/software resources. In typical operating system, the most privileged is the kernel space, also known as Ring 0 in certain processor architectures, which interacts directly with the physical hardware (e.g., the CPU and memory). The least privileged is the user space also known as Ring 3 in certain processor architectures. In a para-virtualized environment, a modified guest runs in Ring 3, and therefore cannot execute instructions that require Ring 0 privileges. Such instructions are referred to herein as privileged instructions. Therefore, on each attempt to execute privileged instructions in Ring 3, the processor executing the instruction raises an exception which in turn leads to an undefined behavior.

FIG. 1 depicts a schematic diagram 100 of the operation of such a prior art para-virtualized system. On a computing hardware 110 there executes a para-virtualizing hypervisor (PVHV) 120 on top of which a modified guest 130 executes, which is modified per the specific needs of the PVHV 120. Specifically, each and every guest planned to be executed on the PVHV must be modified at least to execute privileged instructions, so that the modified guest can operate successfully in the para-virtualized environment. This means that some of the advantages of the para-virtualized environment over the full virtualized environment are offset. Hence, it is understood that this approach, much like the full virtualization, has its drawbacks, in particular the need to modify the guest.

It would be therefore advantageous to provide a solution that overcomes the deficiencies of the prior art by allowing an unmodified guest operating system to run in a para-virtualized environment.

### SUMMARY

Certain embodiments disclosed herein include a method of operation in a para-virtualized environment. The method includes executing a first hypervisor on a hardware platform of a computing device; and executing a second hypervisor over the first hypervisor, the second hypervisor is configured to capture at least a privileged instruction called by an unmodified guest program executed over the second hypervisor and cause the first hypervisor to execute an instruction corresponding to the captured privileged instruction, wherein the unmodified guest program and the second hypervisor operate in a user space protection domain and the at least privileged instruction should be executed in a kernel space protection domain.

Certain embodiments disclosed herein also include an apparatus operating in a para-virtualized environment. The apparatus includes a processor; and a memory coupled to the processor and configured to store at least a first set of instructions for a first hypervisor for execution by the processor and a second set of instructions for a second hypervisor for execution by the processor over the first hypervisor, wherein the first hypervisor is configured to enable execution of an unmodified guest program over the second hypervisor and wherein the unmodified guest program and the second hypervisor operates in a user space protection domain.

Certain embodiments disclosed herein also include a method for isolating an unmodified guest program executed in a para-virtualized environment from a para-virtualized hypervisor. The method comprises executing a para-virtualized hypervisor (PVHV) on a hardware platform of a computing device; executing an interface hypervisor (IHV) over the PVHV; and executing the unmodified guest program over the IHV, wherein the IHV is configured to capture at least a privileged instruction received from the unmodified guest program and cause the PVHV to execute an instruction corresponding to the captured privileged instruction, wherein the unmodified guest program and the IHV operate in a user space protection domain, and the at least privileged instruction should be executed in a kernel space protection domain.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention will be apparent from the following detailed description taken in conjunction with the accompanying drawings.

FIG. 1 is a schematic diagram of a system operating in a para-virtualized environment with a modified guest.

FIG. 2 is a schematic diagram of a system operating in a para-virtualized environment with an unmodified guest according to one embodiment.

FIG. 3 is a flowchart depicting the operation of the interface hypervisor according to one embodiment.

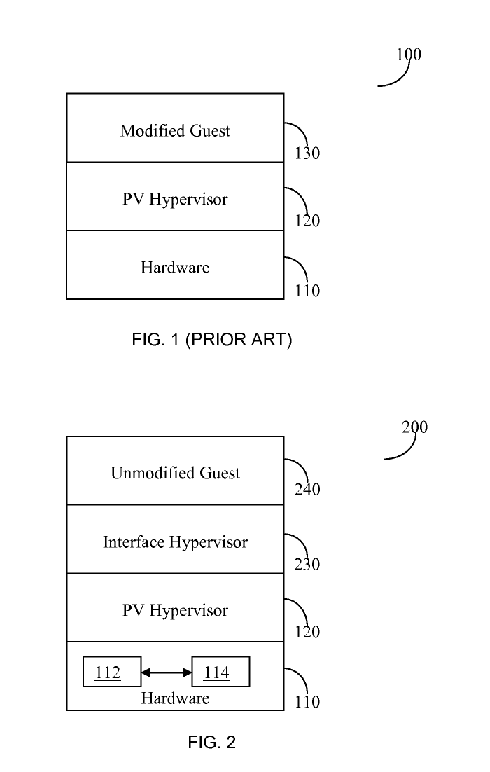

### DETAILED DESCRIPTION

The embodiments disclosed herein are only examples of the many possible advantageous uses and implementations of the innovative teachings presented herein. In general, statements made in the specification of the present application do not necessarily limit any of the various claimed inventions. Moreover, some statements may apply to some inventive features but not to others. In general, unless otherwise indicated, singular elements may be in plural and vice versa with no loss of generality. In the drawings, like numerals refer to like parts through several views.

Various embodiments disclosed herein enable the execution of an unmodified guest in a para-virtualized computing environment. This is in contrast to prior art systems that require a guest be modified to be capable of executing in a para-virtualized environment, where a hypervisor executes on a computing device, and a modified guest is executed thereon.

With this aim of executing an unmodified guest in a para-virtualized environment, a new architecture is provided that includes a second hypervisor that runs on-top of the para-virtualized hypervisor and operates as an in-between layer for an unmodified guest and the para-virtualized hypervisor executed over the computing device. In one embodiment, the second hypervisor translates for the first hypervisor all privileged instructions, which otherwise could not be executed by the para-virtualized hypervisor and would therefore require the modification of the guest.

FIG. 2 depicts an exemplary and non-limiting schematic diagram of a computing system 200 operating in a para-virtualized environment with an unmodified guest according to an embodiment of the invention. On the computing device hardware 110 there executes a para-virtualizing hypervisor (PVHV) 120. The hardware 110 includes at least a processor 112 and a memory unit 114 coupled to the memory. The processor 112 may be a CPU having one or more cores. According to one embodiment, at least a portion of the memory 114 is shared between the PVHV 120 and an unmodified guest 240. The hardware 110 typically also includes other computing resources (not shown in FIG. 2), such as a storage disk, a motherboard, a memory management unit, registers, I/O ports, a network interface card (NIC), a display adapter 216, and the like.

The unmodified guest 240 may be, but is not limited to, a commercially available operating system (OS) that was not purposefully designed, programmed, or configured to operate successfully in a para-virtualized environment. The guest may be, for example and without limitation, a Windows-based OS, a Linux-based OS, iOS, and the like. The PVHV 120 enables the operation in a para-virtualized environment with an unmodified guest 240. With this aim, according to the embodiments disclosed herein, an interface hypervisor (IHV) 230 is provided as an interface operative over the PVHV 120.

Operating generally as a hypervisor, the IHV 230 is modified to capture a set of privileged instructions that require execution in Ring 0 (kernel) of the computing device. The set of privileged instructions may be preconfigured with the IHV 230 and additional instructions may be added as needed. For example, a new version release of the IHV 230 may include additional privileged instructions. In one embodiment, the set of instructions is defined based on the type of the PVHV 120, a list of features supported by the PVHV 120, and so on. The IHV 230 may be also configured to bridge the gap to allow compatibility of other software resources of the unmodified guest 240 and the PVHV 120.

A captured instruction is translated to a corresponding instruction that can be executed by the PVHV 120 in Ring 0. Thus, the PVHV 120 executes the privileged instruction on behalf of the unmodified guest. The results of the executed instruction are exported to a guest by, for example, writing the results to the shared memory portion in the memory unit 114. Upon completion of the instruction's execution, the IHV 230 instructs the unmodified guest 240 to read the execution from the shared memory.

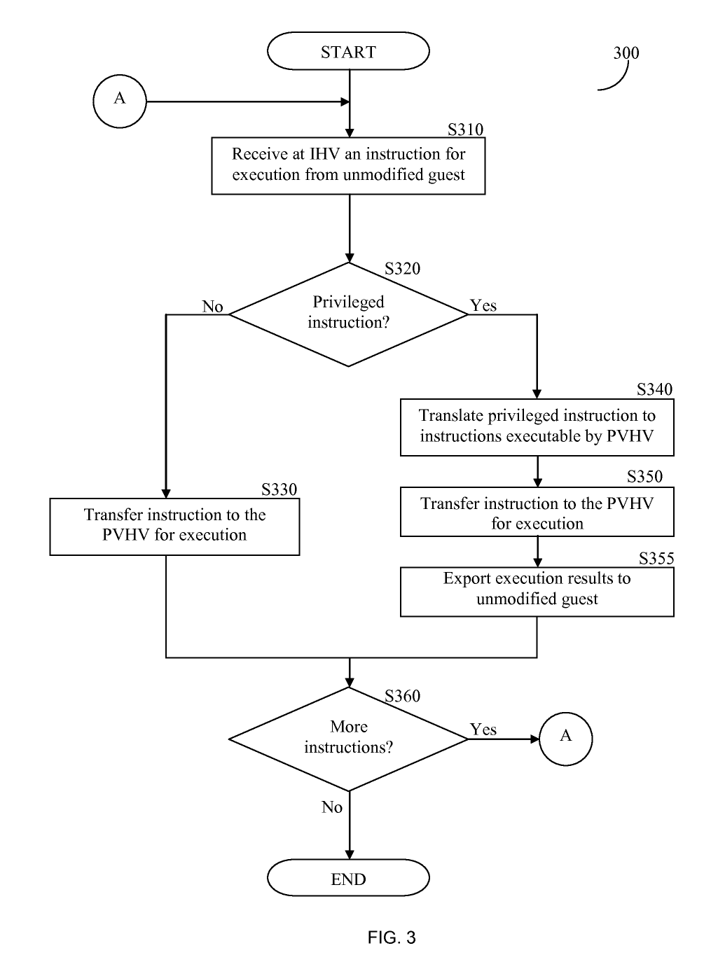

It should be noted that by handling the privileged instructions, and as explained herein below with respect of FIG. 3, it is not necessary to modify the guest as is the case in conventional para-virtualized environment solutions. The unmodified guest 240 is executed over the IHV 230, and it is not necessary to provide for any changes thereto. It should be understood that the IHV 230 operates as an isolation layer between the unmodified guest 240 and the PVHV 120, thereby removing the need to modify the guest to be able to effectively execute over the PVHV 120 directly.

FIG. 3 depicts an exemplary and non-limiting flowchart 300 of the operation of the IHV 230 according to an embodiment of the invention. In S310, the IHV 320 captures an instruction for execution from the unmodified guest 240. As mentioned above, the guest 240 is executed over the IHV 230, thus the IHV 230 can monitor and capture system calls trigged by the guest 240.

In S320, it is checked whether the capture system call is for execution of a privileged instruction, and if so execution continues with S340; otherwise, execution continues with S330. As mentioned above, a privileged instruction is an instruction that requires Ring 0 privileges, but the unmodified guest 240 runs with Ring 3 (user) privileges. Thus, running such instructions in Ring 3 causes a process exception.

In S330, the non-privileged instruction is transferred to the PVHV 120 for execution, followed thereafter by S360. Specifically, the PVHV 120, being a hypervisor that manages the execution of the guest's instructions, can safely execute on the hardware the non-privileged instructions.

In S340, the privileged instruction is translated into an instruction executable by the PVHV 120 without causing any disruption to the execution. Specifically, privileged instructions are translated into para-virtualized application program interface (API) calls provided by the PVHV 120. The translation may be realized, for example, through a hash table that maps a captured privileged instruction to a corresponding para-virtualized API call. The mapping may be performed based on the syntax of the privileged instruction.

In S350, the para-virtualized API call (i.e., a translated instruction(s) corresponding to a privileged instruction) is transferred to the PVHV 120 for execution therein. At S355, the execution results of the privileged instruction are exported to the unmodified guest. In S360, it is checked whether additional instructions are to be executed and if so execution continues with S310; otherwise, execution terminates.

An exemplary and non-limiting use of the invention discussed herein is in conjunction with the XEN® hypervisor, used as the PVHP 120. In such an implementation the following exemplary and non-exhaustive translations using para-virtualized APIs occurs as shown in Table 1.

TABLE 1

| Desired | X86 | |
|---|---|---|
| Action | instruction(s) | XEN API |
| Load global | lgdt | HYPERVISOR_set_gdt |
| descriptor | | |
| table | | |
| Load | lidt | HYPERVISOR_set_trap_table |
| interrupt | | |
| descriptor | | |
| table | | |
| Return from | iret | HYPERVISOR_iret |
| interrupt | | |
| Flush local | mov [reg], cr3, | HYPERVISOR_mmuext_op |
| TLB | mov cr3, [reg] | (MMUEXT_TLB_FLUSH_LOCAL) |
| Flush global | mov [reg], cr4 | HYPERVISOR_mmuext_op |
| TLB | and [reg], | (MMUEXT_TLB_FLUSH_GLOBAL) |
| | ~CR4_PGE | |
| | mov cr4, [reg] | |
| Invalidate | invlpg [addr] | HYPERVISOR_mmuext_op |
| linear | | (MMUEXT_INVLPG_ALL) |
| address | | |
| Set | mov [seg_reg], | HYPERVISOR_update_descriptor |
| segment | [reg] | |
| descriptor | | |

The column “Desired Action” describes an action that the unmodified guest attempts to perform. In the “X86 Instruction(s)” column the respective instruction or instructions for the desired action to be performed by the unmodified guest are shown. The X86 Instruction(s) are executed by the processor of a computing device, thus these instructions if executed by directly by the unmodified guest would trigger an exception by the processor. In the “XEN API” column respective XEN hypervisor API calls for the X86 instructions are shown. The X86 instructions column lists a privileged instruction, while the Xen API column shows a corresponding API call used to handle the case of such privileged instruction. These XEN API calls are implemented by the XEN hypervisor and exported to a guest by means of the shared memory.

It should be noted that one of ordinary skill in the art would readily appreciate that such implementation would not be limited to the XEN hypervisor, and other para-virtualized environments may benefit from the invention. Hence, the mere example should not be viewed as limiting upon the scope of the invention. Specifically, the examples give hreinabove where with respect to a ring domain protection, specifically Ring 3 and Ring 0, however, other user space and kernel space domain protection is possible without departing from the scope of the invention.

The various embodiments disclosed herein may be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the invention and the concepts contributed by the inventor to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. An apparatus operating in a para-virtualized environment, comprising:
a processor; and
a memory coupled to the processor and configured to store at least a first set of instructions for a first hypervisor for execution by the processor and a second set of instructions for a second hypervisor for execution by the processor over the first hypervisor, wherein the first hypervisor is configured to enable execution of an unmodified guest program over the second hypervisor and wherein the unmodified guest program and the second hypervisor operate in a user space protection domain.

2. The apparatus of claim 1, wherein the second hypervisor is configured to capture at least a privileged instruction called by the unmodified guest program and translate the at least privileged instruction to at least a corresponding instruction of the first set of instructions executable by the first hypervisor without causing an exception, wherein the at least privileged instruction should be executed in a kernel space protection domain.

3. The apparatus of claim 2, wherein execution results of the corresponding instruction are exported to the unmodified guest program.

4. The apparatus of claim 3, wherein the execution results are written to a shared memory portion in the memory shared between at least the unmodified guest program and the first hypervisor.

5. The apparatus of claim 2, wherein the first hypervisor is a para-virtualized hypervisor.

6. The apparatus of claim 5, wherein the first set of instructions are executed in a kernel space protection domain.

7. The apparatus of claim 6, wherein the kernel space protection domain is Ring 0 and the user space protection domain is Ring 3.

8. The apparatus of claim 2, wherein the translation includes the use of an application program interface (API) provided by the first hypervisor.

9. The apparatus of claim 1, wherein the unmodified guest program is an operating system that was not purposefully designed, programmed, or configured to operate successfully in the para-virtualized environment.

10. A method of operation in a para-virtualized environment, comprising:
executing a first hypervisor on a hardware platform of a computing device; and
executing a second hypervisor over the first hypervisor, the second hypervisor is configured to capture at least a privileged instruction called by an unmodified guest program executed over the second hypervisor and cause the first hypervisor to execute an instruction corresponding to the captured privileged instruction, wherein the unmodified guest program and the second hypervisor operate in a user space protection domain and the at least privileged instruction should be executed in a kernel space protection domain.

11. The method of claim 10, wherein the user space protection domain is Ring 3 and the kernel space protection domain is Ring 0.

12. The method of claim 10, wherein responsive of capturing the at least privileged instruction by the second hypervisor, further comprising:
translating by the second hypervisor the at least privileged instruction into at least the corresponding instruction executable by the first hypervisor without causing an exception.

13. The method of claim 12, wherein the translation includes the use of an application program interface (API) provided by the first hypervisor.

14. The method of claim 12, wherein execution results of the corresponding instruction are exported to the unmodified guest program.

15. The method of claim 10, wherein the first hypervisor is a para-virtualized hypervisor.

16. The method of claim 15, wherein the unmodified guest program is an operating system that was not purposefully designed, programmed, or configured to operate successfully in the para-virtualized environment.

17. A non-transitory computer readable medium having stored thereon instructions for causing one or more processing units to execute the method according to claim 10.

18. A method for isolating an unmodified guest program executed in a para-virtualized environment from a para-virtualized hypervisor, comprising:
executing a para-virtualized hypervisor (PVHV) on a hardware platform of a computing device;
executing an interface hypervisor (IHV) over the PVHV; and
executing the unmodified guest program over the IHV, wherein the IHV is configured to capture at least a privileged instruction received from the unmodified guest program and cause the PVHV to execute an instruction corresponding to the captured privileged instruction, wherein the unmodified guest program and the IHV operate in a user space protection domain and the at least privileged instruction should be executed in a kernel space protection domain.

19. The method of claim 18, wherein the user space protection domain is Ring 3 and wherein the kernel space protection domain is Ring 0.

20. The method of claim 18, wherein the IHV is further configured to:
translate the at least privileged instruction to the corresponding instruction by use of an application program interface (API) provided for the PVHV.

21. The method of claim 18, wherein execution results of the corresponding instruction are exported to the unmodified guest program.

22. The method of claim 18, wherein the unmodified guest program is an operating system that was not purposefully designed, programmed, or configured to operate successfully in the para-virtualized environment.

23. A non-transitory computer readable medium having stored thereon instructions for causing one or more processing units to execute the method according to claim 18.
